(19) United States
(12) Patent Application Publication
(10) Pub. No.: US 2005/0061779 A1
(43) Pub. Date: Mar. 24, 2005

(54) Laser ablation feedback spectroscopy

(76) Inventors: Walter Blumenfeld, Airville, PA (US); Joseph D'Entremont, Glen Arm, MD (US); Robert Gidner, Glen Arm, MD (US)

Correspondence Address: LAW OFFICES OF ROYAL W. CRAIG;A PROFESSIONAL COPORATION, SUITE 153, 10 NORTH CALVERT STREET, BALTIMORE, MD, 21202, US

(21) Appl. No.: 10/913,138

(22) Filed: Aug. 6, 2004

Related U.S. Application Data
(60) Provisional application No. 60/492,940, filed on Aug. 6, 2003.

(51) Int. Cl. B23K 26/00

(52) U.S. Cl. 219/121.6

(57) ABSTRACT

Methods, for use with a laser ablation or drilling process, which achieve depth-controlled removal of composite-layered work-piece material by real-time feedback of ablation plasma spectral features. The methods employ the use of electric, magnetic or combined fields in the region of the laser ablation plume to direct the ablated material. Specifically, the electric, magnetic or combined fields cause the ablated material to be widely dispersed, concentrated in a target region, or accelerated along a selected axis for optical or physical sampling, analysis and laser feedback control. The methods may be used with any laser drilling, welding or marking process and are particularly applicable to laser micro-machining. The described methods may be effectively used with ferrous and non-ferrous metals and non-metallic work-pieces. The two primary benefits of these methods are the ability to drill or ablate to a controlled depth, and to provide controlled removal of ablation debris from the ablation site. An ancillary benefit of the described methods is that they facilitate ablated materials analysis and characterization by optical and/or mass spectroscopy.

### CROSS-REFERENCE TO RELATED APPLICATIONS

The present application derives priority from U.S. Provisional Patent Application 60/492, filed: Aug. 6, 2003

### BACKGROUND OF THE INVENTION

1. Field of Invention

The present invention relates to laser drilling, marking and welding, and more particularly, to reduction of work-piece surface contamination by ablation debris, and to precision depth control of laser ablation.

2. Description of the Background

One of the long-standing technical problems in laser micro-machining is work-piece surface contamination by ablated material which falls back on the surface in the area of the laser focus and adheres to it. Such contamination may cause undesirable physical surface artifacts, which may interfere with optical or fluidic properties in the intended use of the work-piece. Furthermore, such debris may be extremely difficult to remove from the surface of some materials.

One common practice for controlling ablation debris involves the use of an inert gas flow over the laser ablation region. This is intended to prevent oxidizing reactions, cool the plume and work-piece, and flush the ablated material away. Unfortunately, as the geometry of the laser focus is reduced in size and instantaneous laser power is increased, this technique becomes less effective.

There are methods for materials analysis by mass spectrometry which involve sample desorption (or ablation), molecular dissociation and ionization by a focused laser beam. This class of instrumentation utilizes an electric field to collect and accelerate the ionized sample, then applies a magnetic field to direct the ionized sample along an axis for subsequent mass/charge ratio analysis by a mass analyzer (typically time-of-flight, magnetic sector, or quadrupole mass analyzers). The techniques developed for ionized sample spatial control in mass spectrometry may be readily applied to control of a laser ablation plume and ionized debris, thereby preventing that debris from returning to the work-piece surface and reducing the total residual surface contamination.

Accordingly, it would be greatly advantageous to provide new methods for control of laser ablation debris which are effective on a microscopic scale and with the use of high-energy laser pulses of very short duration.

Another technical problem in application of laser drilling in composite or layered materials (especially for the semiconductor manufacturing industry) is accurate depth control for laser-drilling blind holes. Optical interrogation of laser ablation plasma for characteristics of the ablated material (as in LIBS or Laser Induced Breakdown Spectroscopy) is now a standard analytical procedure. By adapting related optical and/or mass spectroscopic methods for real-time detection of change in ablated material composition, laser drilling of blind holes may be accurately controlled.

### SUMMARY OF THE INVENTION

It is an object of this invention to provide new methods of controlling laser ablation debris that are effective on a microscopic scale and with the use of high-energy laser pulses of very short duration. Specifically, it is an object of this invention is to provide methods of applying an electric field, a magnetic field, or a combination of the two for control of a laser ablation plume and its associated ablation debris, in order to reduce the amount of work-piece surface contamination by such ablation debris.

A further object of this invention is to provide methods for real-time sampling of ablation plasma spectra, extraction of characteristic spectral feature signals, and control of ablation depth by use of these signals as process feedback.

More specifically, objects of this invention are: (1) to establish control of laser ablation plume geometry to facilitate interrogation of the ablated plasma by optical emission spectroscopy; (2) to direct the flow of ionized debris along a selected axis for analysis by mass spectrometry; (3) to direct the flow of ionized debris to a target electrode from which an electrometer measures ion current and may serve as a feedback control for the ablation laser power; (4) to optically sample real-time ablation plasma for emission/absorbance spectra and extract characteristic features for control of ablation depth; or (5) to optically sample the work piece ablation site for reflectance or absorbance changes as indicators of ablation depth in a layered work piece.

According to the present invention, the above-described objects are accomplished by the following:

(1) A first form of the invention applies a high positive DC voltage to the work-piece surface in order to repel any positively-charged debris, and provides a ground-potential shield or electrode ring to attract and retain charged debris. The electrode may be connected to a trans-impedance amplifier for measurement of ion current and feedback control of laser power.

(2) A second form of the invention provides layers of insulating and conductive masks or coatings applied to the work-piece, allowing a DC power supply to generate an electric field close to the work-piece surface.

(3) A third form of the invention provides a work-piece fixture in which annular insulating and conductive washers are placed upon the work-piece surface, allowing a DC power supply to generate an electric field close to the work-piece surface.

(4) A fourth form of the invention simply provides a permanent magnet or DC electromagnet located near the work-piece fixture so that a strong magnetic field deflects the plume axis and diverts residual debris away from the ablation surface region.

(5) A fifth form of the invention applies an RF magnetic field to provide enhanced dispersion of the ablation plume over a large volume distant from the work-piece surface.

(6) A sixth form of the invention applies electric and/or magnetic fields to direct the ablation plume to the sample aperture of an optical emission spectrometer or to the inlet orifice of a mass analyzer. In addition to limiting the deposition of ablation residue on the work-piece surface, this enables ablated materials analysis for ablation depth-control feedback or for quality control of the finished work-piece.

(7) A seventh embodiment of the invention places the sampling aperture of a fiber-coupled spectrometer (remotely located) so that it has the laser ablation plasma in its field of view. When the laser begins to ablate material from a deeper layer of composite work-piece material, the emission spectrum will change. The plasma emission in view of the sampling aperture follows this change and the fiber-coupled spectrometer interprets it and forwards a signal to the laser controller to terminate ablation. This provides accurate depth control in composite material ablation.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 illustrates a first embodiment of the present invention.

FIG. 2 is an enhanced perspective of the first embodiment of the present invention.

FIG. 3 is a cross-sectioned view of the second embodiment of the present invention.

FIG. 4 illustrates the third embodiment of the present invention.

FIGS. 5 and 6 depict the fourth embodiment of the present invention invention.

FIG. 7 illustrates a fifth embodiment of the present invention.

FIG. 8 illustrates a sixth embodiment of the present invention.

FIG. 9 illustrates a seventh embodiment of the present invention.

### DETAILED DESCRIPTION OF THE INVENTION

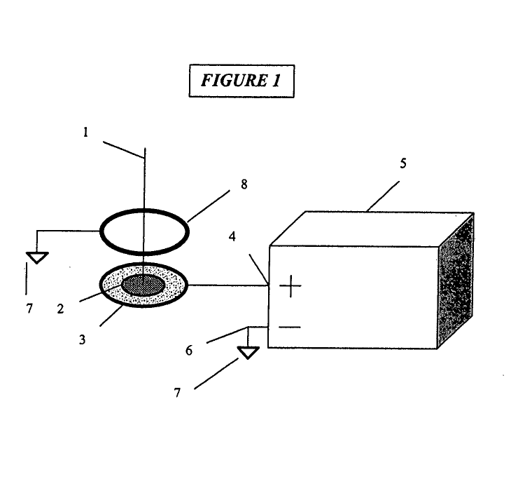

A first embodiment of the present invention is depicted in FIG. 1. The optical axis 1 of a laser ablation device (not shown) is centered on a work-piece 2, which is retained in an electrically conductive chuck or holding fixture 3. The work-piece 2 and holder 3 are connected to a DC power supply 5 by a wire 4 attached to its positive output. The negative output of power supply 5 is connected by another wire 6 to earth ground 7. This circuit places a positive voltage potential on the work-piece 2 surface. A circular electrode ring 8 connected to earth ground 7 is located above the work-piece 2 and centered about the optical axis 1; this establishes an electric field above the work-piece such that positively ionized particles from the laser ablation plume are attracted to the electrode ring. Furthermore, any positively charged particles from the ablation plume that escape attraction to the electrode ring (by virtue of excess kinetic energy) are repulsed from the positively charged surface of the work-piece.

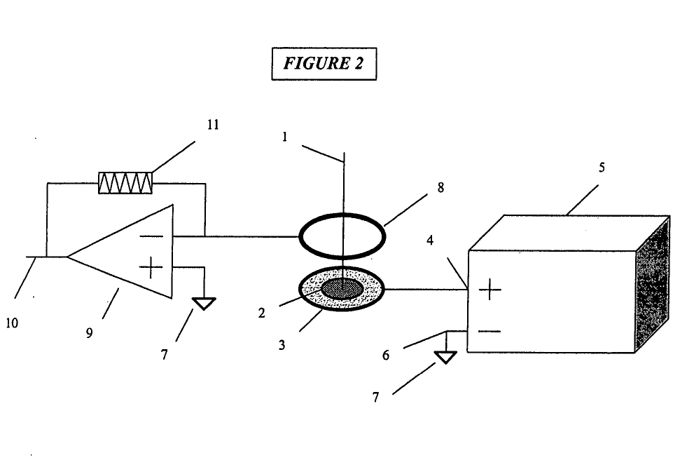

An enhanced version of the first embodiment is shown in FIG. 2. The electrode ring 8 is maintained at earth ground potential 7 by the trans-impedance amplifier 9, which has its sensitivity set by feedback resistor 11. The feedback current flowing through the resistor 11 is equal to the ablation ion current captured by the electrode ring 8, and the voltage output signal 10 is directly proportional to the ablation ion current. This signal may be read out as an indication of ablation performance, or it may be used as a feedback control on laser power to maintain a specified ablation ion current set-point.

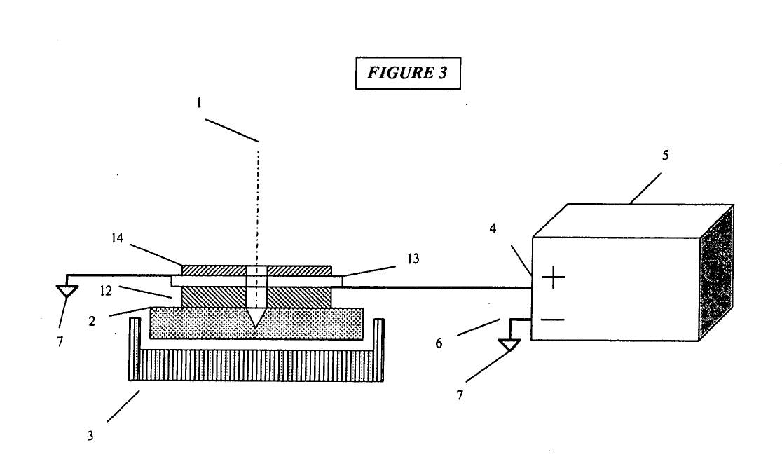

A second embodiment of the invention is shown in cross-section in FIG. 3. The work-piece 2 is supported in the holder 3. A first conductive mask or film 12 is located in intimate contact with the upper surface of the work-piece 2, and retained by any method such as an adhesive, clamps or gravity. The first conductive mask or film 12 is connected by wire 4 to the positive output of a DC power supply 5, whose negative output is connected to earth ground 7. An insulating mask or film 13 is applied to the upper surface of the first conductive mask or film 12. A second conductive mask or film 14 is applied to the upper surface of the insulating mask or film 13 and connected to earth ground 7. As the laser ablation proceeds along the optical axis 1, it ablates through the successive layers of masks 14, 13, 12 and then commences to ablate the work-piece 2. The positively ionized particles in the ablation plume are repelled by the positively charged first conductive film or mask 12 on the upper work-piece 2 surface, and attracted away from the work-piece 2 surface by the (relative) negative charge on the second conductive mask or film 14.

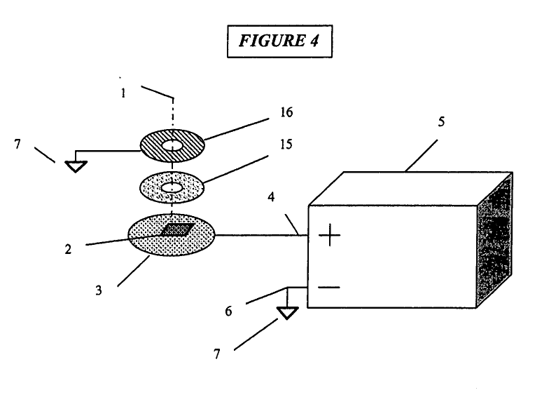

In a third embodiment of the invention, FIG. 4, the work-piece 2 is positioned on a conductive holder 3, which is connected by a wire 4 to the positive output of a DC power supply 5. The work-piece 2 is covered by an insulating washer 15. The insulating washer 15 is covered by a conductive washer 16 that is connected to earth ground 7. The DC power supply 5 has its negative output connected to earth ground 7 by another wire 6. This embodiment of the invention functions in a manner similar to the second embodiment (FIG. 3), with the difference being that the optical axis is centered in the apertures of the washers 15, 16 so that the ablation process does not act on any material other than the work-piece 2.

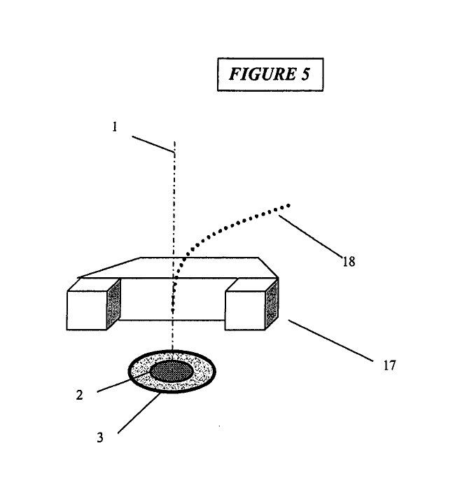

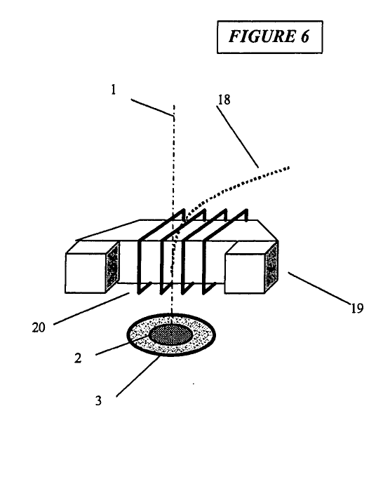

A fourth embodiment of the invention is shown in FIG. 5. A permanent magnet 17 is located near the optical axis near the ablation site on the work-piece 2. The magnetic field deflects the charged particles in the ablation plume through a curved path 18, whose radius and direction are dependent on the strength and geometry of the magnetic field, the mass/charge ratio of each particle in the plume, and the initial velocity vector of each particle. The same result is achieved as shown in FIG. 6, in which a DC electromagnet 19 energized by windings 20 creates the magnetic deflection field.

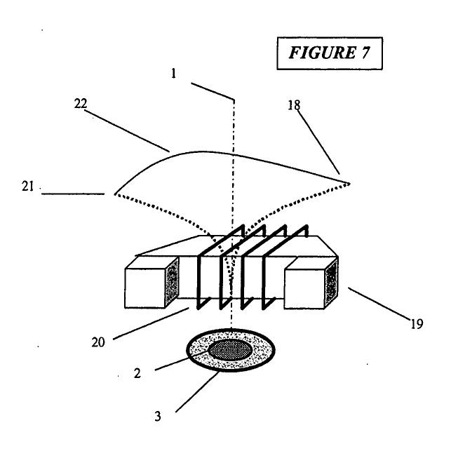

A fifth embodiment of the invention is shown in FIG. 7. In this case, an electromagnet 19 is driven by an AC power supply (not drawn), which may operate in either CW or pulsed mode, at frequencies up to and including RF. The limiting deflection paths 18, 21 of the charged particles in the ablation plume determine a curved fan shape 22, in which most of the ablation debris is projected.

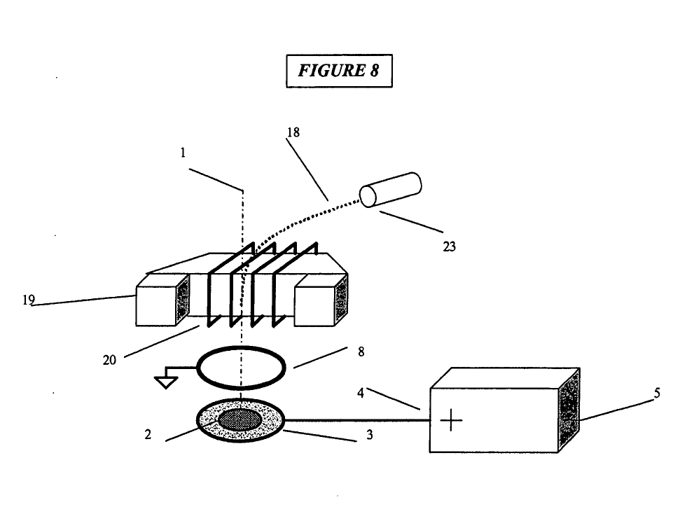

A sixth embodiment of the invention is presented in FIG. 8. The positively charged particles in the ablation plume are accelerated by an electric field in the region between the work-piece 2 and the electrode ring 8. An electromagnet 19 generates a magnetic field in response to an electric current directed through windings 20. The path of the positively charged ablation particles 18 is deflected by the magnetic field into a sampling aperture 23. The sampling aperture 23 may be the aperture of an optical instrument such as a photometer, a spectrometer, or a densitometer. The sampling aperture may also be the target electrode or target array in a magnetic-sector, quadrupole, or time-of-flight mass analyzer. The sampling aperture may also be the sample inlet port of an analytical instrument such as a gas chromatograph, fluorometer or mass spectrometer. In each variation of this embodiment, the ablation particles directed to the sample aperture may be used for control of the ablation laser and/or for physical & chemical analysis of the ablated material; this provides improved control of the ablation process and an additional means for in-process acceptance testing of each work-piece.

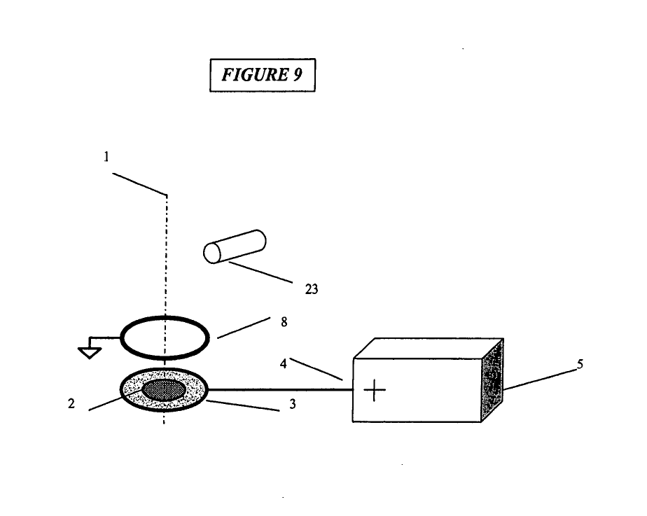

A seventh embodiment of the invention is shown in FIG. 9. As in the first embodiment of FIG. 1, an electric field is established above the work-piece such that positively ionized particles from the laser ablation plume are attracted to the electrode ring 8. The sampling aperture 23 of a fiber-coupled spectrometer (remotely located) is positioned so it has the laser ablation plasma in its field of view. The positively-charged ablation particles are constrained by the electric field to pass within the field of view of the sampling aperture 23. The analog electrical or digitally represented plasma emission spectrum is characteristic of the ablated material. Consequently, when the laser begins to ablate material from a new layer of composite work-piece material, the emission spectrum changes. The sampling aperture 23 views this altered optical emission and the fiber-coupled spectrometer interprets it and forwards a signal to the laser controller to terminate ablation. This provides accurate depth control in composite material ablation.

In each of the embodiments listed herein, the application of control fields to the laser ablation process may be practiced in an environment of normal atmosphere, inert gas mixtures, reactive gas mixtures, optically transparent fluids, or vacuum; choice of the ablation environment will be dependent on the materials and process requirements of each particular ablation task.

1. A method for controlling a laser ablation plume and its associated ablation debris by establishing an electric field above a work piece such that positive ionized particles from the laser ablation plume are both attracted to a negative-potential electrode ring and repulsed away from the work piece surface, such method consisting of: (1) fixing a work piece into an electrically-isolated conductive chuck or holding fixture, (2) centering the optical axis of an optical laser ablation device on said work piece; (3) connecting both said work piece and the chuck or holding fixture by a wire to the positive output of a DC power supply and connecting its reference ground by wire to the negative output of said DC power supply in order to form a circuit which places a positive voltage potential on the surface of said work piece, and (4) centering a ground (or negative) potential electrode ring in a position above the work piece, encircling the optical axis of the laser ablation device in order to establish an electric field above the work piece.

2. The method of claim 1 wherein, the electrode ring is maintained at ground potential by a trans-impedance amplifier, said amplifier having its sensitivity set by a feedback resistor, said resistor producing a signal which may be used as either an indication of ablation performance or a feedback control on laser power to maintain a specified ablation ion current setpoint.

3. The method of claim 1 wherein, the laser ablation plasma is constrained to intersect the field of view of an optical emission spectrometer, photometer, or other optical analytical instrument or sensor; one or more features of the optical signal is used for feedback control of the laser ablation process in order to provide power control, rate control or depth control.

4. The method of claim 1 wherein, the laser ablation plasma is directed to the sample inlet of a mass analyzer, mass spectrometer, or other chemical sensor; one or more features of the analyzer, spectrometer or sensor signal is used for feedback control of the laser ablation process in order to provide power control, rate control or depth control.
